(19) United States
(12) Patent Application Publication
(10) Pub. No.: US 2026/0017719 A1
(43) Pub. Date: Jan. 15, 2026

(54) METHOD AND APPARTUS FOR TRAINED COMPUTER MODEL MANAGEMENT

(71) Applicant: Liberate AI Limited, London (GB)

(72) Inventors: Nicholas KASSAM, High Wycombe (GB); Arjang ZADEH, London (GB)

(73) Assignee: Liberate AI Limited, London (GB)

(21) Appl. No.: 18/881,778

(22) PCT Filed: Jul. 5, 2023
(86) PCT No.: PCT/GB2023/051781

§ 371 Date: Jan. 7, 2025

(30) Foreign Application Priority Data
Jul. 8, 2022 (GB) 2210052.3

(51) Int. Cl. G06Q 40/04; H04L 9/00; H04L 9/08

(52) U.S. Cl. CPC G06Q 40/055; H04L 9/0841; H04L 9/50

(57) ABSTRACT

A method of providing a computer model as a tradeable asset is described. A trained computer model is prepared—this comprises developing and training a computer model using training data and determining acceptance criteria for the computer model such that the computer model is determined to be a trained computer model when the acceptance criteria are met. The trained computer model is packaged for use by a third party and stored securely. A token corresponding to the trained computer model is established. The token, and transactions in the token, are posted to a blockchain such that the token is adapted for use as a tradeable asset. Access to the trained computer model is provided to a third party who has acquired rights to use the trained computer model through obtaining rights in the token. An associated system for developing of a computer model and for providing it as a tradeable asset is also described.

### FIELD OF THE INVENTION

This invention relates to a method and apparatus for trained computer model management.

### BACKGROUND

Machine learning (ML) is increasingly used to address a very wide range of problems in real-world environments. There are a large number of algorithmic approaches available for development of computer models based on training data. The development of a model will typically involve use of one or more of these algorithms on the training data in an iterative model development process until a model is developed that meets desired effectiveness criteria.

In more or less any real-world situation, this process is not wholly automatic. The role of a human application domain expert will in practice be critical to determining effectiveness criteria at the very least, but often also in shaping the whole process of model development (for example, by determining which variables to evaluate and how). “Domain” here can be considered very broadly—it can be considered to apply to any problem context for which real-world knowledge is necessary for proper evaluation of the problem or its solution.

Development of computer models using best practice in machine learning typically requires specialized tools and techniques—these are typically not accessible to, and not controlled by, domain experts in most application domains. There is often little incentive for such domain experts to become involved in computer model development—they will be faced with developing significant expertise outside their own domain to develop models themselves, or to provide their knowledge to model developers without a clear path to reward if the resulting computer model proves to have significant value. It would be desirable to have a process for computer model development that enabled and rewarded easy interaction with domain experts who are not themselves machine learning experts.

It is against this background that the present invention has been devised.

### SUMMARY OF THE INVENTION

In a first aspect, the invention provides a method of providing a computer model as a tradeable asset, comprising: preparing a trained computer model, comprising developing and training a computer model using training data and determining acceptance criteria for the computer model such that the computer model is determined to be a trained computer model when the acceptance criteria are met; packaging the trained computer model for use by a third party and storing the trained computer model securely; establishing a token corresponding to the trained computer model; posting the token and transactions in the token to a blockchain such that the token is adapted for use as a tradeable asset; and providing access to the trained computer model to a third party who has acquired rights to use the trained computer model through obtaining rights in the token.

Using this approach, the contribution of the model developer can be appropriately protected and rewarded. The provision of the trained computer model in a securely stored form, with access granted to those who have acquired rights through a token, are key elements of a technical infrastructure that enables this goal to be achieved.

In embodiments, the trained computer model is a machine learning model. The process of preparing the trained computer model may comprise iterating a process of feature selection, algorithm selection, model building and model testing until the acceptance criteria are met.

This approach to preparation of a trained computer model allows for effective interaction of a domain expert—who may, for example, have a critical role in determining acceptance criteria—with the model preparation system.

Packaging the trained computer model may further comprise a model creator digitally signing the trained computer model. Storing the trained computer model securely may comprise storing the trained computer model in encrypted form encrypted by a key controlled by a model creator or model owner. Establishing the token may comprise applying a hash function to the trained computer model and signing a hash result with a model creator private key.

In embodiments, providing access to the trained computer model to the third party may comprises establishing a shared secret between the third party and a model owner or model creator, and encrypting means of access to the trained computer model using the shared secret. Such a shared secret may be established using Diffie-Hellman Key Exchange.

In a second aspect, the invention provides a system for developing of a computer model and providing it as a tradeable asset, the system comprising: a model creation module adapted for a user to develop and train a computer model using training data and to determine that the computer model meets predetermined acceptance criteria, thereby producing a trained computer model; a model packaging module for packaging the trained computer model for use by a third party, for storing the trained computer model securely, and for establishing a token corresponding to the trained computer model; and a model management module for posting the token and transactions in the token to a blockchain such that the token is adapted for use as a tradeable asset, and for providing access to the trained computer model to a third party who has acquired rights to use the trained computer model through obtaining rights in the token.

### BRIEF DESCRIPTION OF THE DRAWINGS

In order that the invention may be more readily understood, preferred non-limiting embodiments thereof will now be described, by way of example only, with reference to the accompanying drawings, in which:

FIG. 1 illustrates elements of an ecosystem for computer model development and use to which embodiments of the invention may be applied;

FIG. 2 illustrates a process for computer model development and packaging according to an embodiment of the invention;

FIG. 3 illustrates the process of packaging a computer model as a tradeable artefact as shown in FIG. 2 in more detail;

FIG. 4 indicates a security model for distribution and use of packaged computer models; and

FIG. 5 illustrates a process of packaged computer model management using a distributed ledger.

### SPECIFIC DESCRIPTION

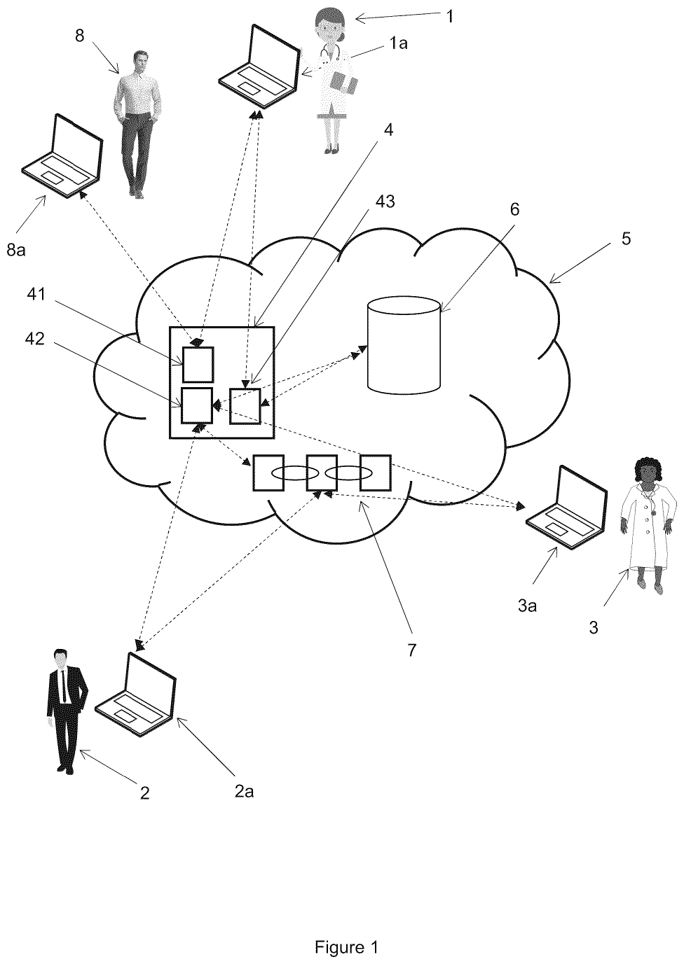

FIG. 1 shows an infrastructure in which embodiments of the invention may be employed. A model creator 1 using their computing apparatus 1a here interacts with a model development and management service 4, here shown as a service accessed over the cloud 5 or through some other network connection. This service 4 will of course be implemented over appropriate computer architecture, in particular suitably programmed processors interacting with memories. Three modules are shown within the model development and management service 4: a model creation tool 41, a model packaging tool 42, and a model management service 43. Models, when created, are stored in a secure model storage 6. Rights in models are managed with the assistance of a blockchain 7. In this way model owners 2 (interacting through their computing apparatus 2a) and model users 3 (interacting through their computing apparatus 3a) form part of an effective ecosystem for development and use of models. Another possible party to the ecosystem is a model trainer 8, again using their own computing apparatus 8a. The different elements of this ecosystem are described in greater detail below.

Four different human roles are shown in FIG. 1. These roles have the following significance:
The model creator 1 (MC) is the creator of the collection of artefacts that collectively represent the model—individual elements (such as specific algorithms) may have been created by others, but the collection is the responsibility of the model creator 1, who will typically here be an application domain expert. This role will not change over time, whereas others (such as model owner 2) may well do so.
The model owner 2 (MO) is the entity with legal ownership of the model. As the model is a transferable commodity, as discussed below, different entities may take this role over time.
The model user 3 (MU) is simply a party using the model—they will acquire rights to do this typically from the model owner 2 or by an agent or service acting on the model owner's behalf. In practice, the model user 3 may simply be a software component licensed to use the model.
The model trainer 8 (MT) is capable of further training an already developed model—the services of a model trainer 8 may be required by a model user 3 in order to adapt the model to a particular user problem or user circumstances. The model trainer 8 may have model development expertise or subject matter expertise (possibly obtained from the model creator 1). It is assumed that the model trainer 8 will not have rights in any derivative works created.

It should be noted that a single entity may take more than one of these roles—for example, the model creator 1 may be the initial model owner 2, or the model creator 1 may also take the role of model trainer 8.

In embodiments of the invention, the following processes take place in the ecosystem. The model creator 1 first creates the model using the model creation tool 41. When the model has been created, it is packaged using the model packaging tool 42 and stored in a secure packaged form in the secure model storage 6. In addition, the model packaging tool 42 creates a tokenized form of the packaged model—here termed a Non-Fungible Model, by analogy to non-fungible token—which can be managed as a tradeable asset through the model management service 43. The model management service 43 is supported by a blockchain 7 which stores information relating to ownership of and rights in the packaged model in an immutable way. The model management service 43 supports trading of models in a variety of ways.

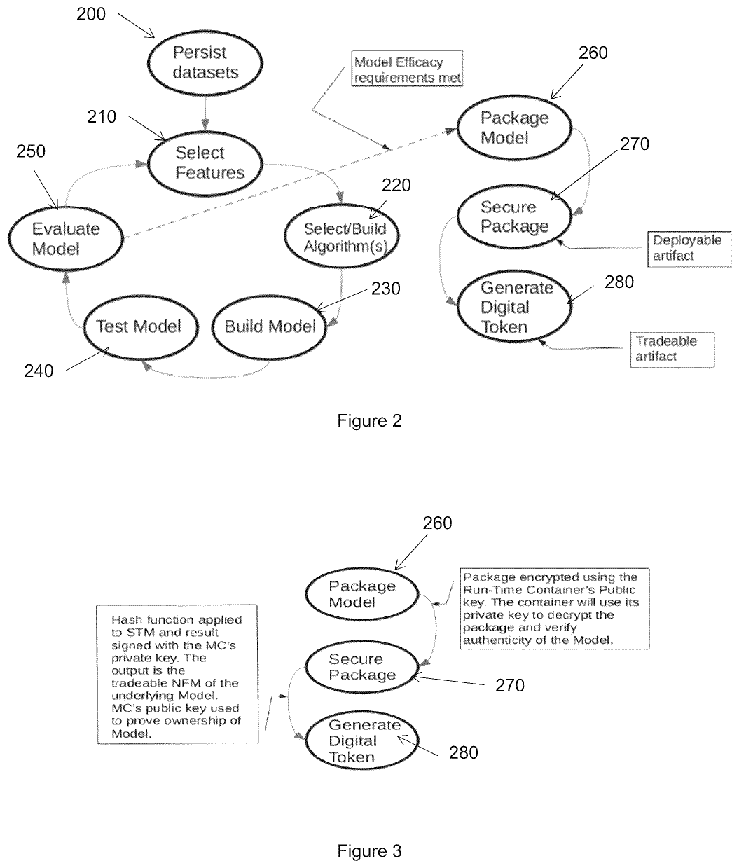

These processes will now be described in more detail. FIG. 2 indicates steps involved in model training and establishment of a packaged model. The model, in its broadest sense, is a set of algorithms implemented using one or more computer languages—a trained model has parameters developed through training by use of training data (typically real-world data or data extrapolated from real-world data). The invention does not require use of any specific algorithms and may use conventional machine learning training processes—none of this is fundamental to the invention, which relates rather to how the expertise used in the model development and training process is captured and protected, and in how the resulting trained model is stored and used.

Consequently, the process of model training may be essentially conventional, typically requiring the following steps to be present:
Generation and persistence of relevant, clean and consistent data.
Selection of training data from the data available
Use of test data to validate the model
Provision of suitably prepared training data for machine learning pipelines
Execution of machine learning training pipelines and result verification.
Determination of the efficacy of the model against test (possibly labeled) data

These steps will typically require knowledge from computer scientists, data scientists and domain experts. An untrained model may be primarily the product of computer science and data science expertise—typically, this will involve development of new algorithms and curation of old ones, development of an appropriate execution pipeline, and establishment of verification processes—but in embodiments such as that shown in FIG. 1, this may be provided as a generic process and a toolkit from which a trained model can be derived. The trained model, by contrast, uses expertise from all three expert types but the role of the domain expert will generally be critical for any domain-specific model. In embodiments of the invention, it is considered that an untrained model may be provided through an interface with which a domain expert can interact, so that a trained model can be developed which is essentially the product of the domain expert as they have made the choices and decisions that determines the form of the trained model. It is this trained model, embodying the expertise of the domain expert, which is then packaged and protected and made available as a tradeable asset.

It should be noted that while the specific use case considered above is that where the choices and decisions are made by the domain expert alone, this is not necessarily the case—the “model creator” may be a team, or may be another form of expert (for example, a data scientist) who has obtained the necessary level of domain knowledge from another source.

FIG. 2 shows the model creation process. As the skilled person will appreciate, the steps carried out here are broadly conventional for machine learning based model development and individual steps consequently do not need to be described in detail here. The initial step is to establish 200 the data sets for use in the training process—both for training and testing the model—which requires that the data sets need to be appropriately curated to be clean and representative of the system to be modelled. After this, features to be used in the model are selected 210—this need not be all of the features in the data set—and algorithms for the model are selected or built 220 from the algorithms available. These are then used to build 230 the whole model using training data from the data set, which is then tested 240 using test data from the data set. The test results are then evaluated 250 to determine whether they meet criteria for efficacy of the model—this is a point where the contribution of the domain expert is usually particularly important—and if they do meet these criteria an effective model has been developed and the process can continue to the packaging 260, protecting 270 and tokenization 280 of the model. If these criteria are not met, the process returns to the feature selection step 210, and will iterate until the model efficacy criteria are met (or the process is abandoned).

The packaging step 260 and subsequent steps are shown in more detail in FIG. 3. Once the efficacy requirements have been met, the result is a trained model. This is, in principle, available for use in the real-world situations for which it has been trained. The trained model may at this point be a collection of artefacts (metadata, binaries, scripts, static libraries and other artefacts specific to the model “container”) which can be deployed by a model user—they may, for example, be adopted to deploy automatically when loaded to a model user device, or may be adapted to deploy with a model deployment application on model user computing apparatus. These artefacts, organized within a container, are the packaged model. While deployable, this form of the trained model is not secure.

For the model to be in a secure form, it needs to be encrypted, and held in such a way that a model user can access it—these steps are here carried out by the model packaging tool 42. The step of securing 270 the package can be carried out using conventional asymmetric cryptography using a Public Key Infrastructure. The container containing the trained model artefacts can be signed by a model creator private key so that it can be authenticated by any party with access to the model creator public key. The packaged model may be stored in an inherently secure storage 6, or may be stored in an encrypted form within the secure storage 6 so that it can be accessed only by the model creator or their delegate (for example, by encryption with a public key for which the model creator controls the private key).

The product of this step is the secure trained model (STM) itself, though as will be discussed further below, there will be further secure processes involved in making the STM available for use to the model user. At this point, the digital asset associated with the secure trained model—the Non-Fungible Model (NFM) is also created 280. This needs a digital identity that it is distinctive of the NFM, which may be achieved by applying a hash function (any conventional hash function suitable to the amount of data provided may be used) with the result signed by a model creator private key. This digital representation of the STM is what is stored on the blockchain 7 and which is used for establishing (and trading) ownership and use rights.

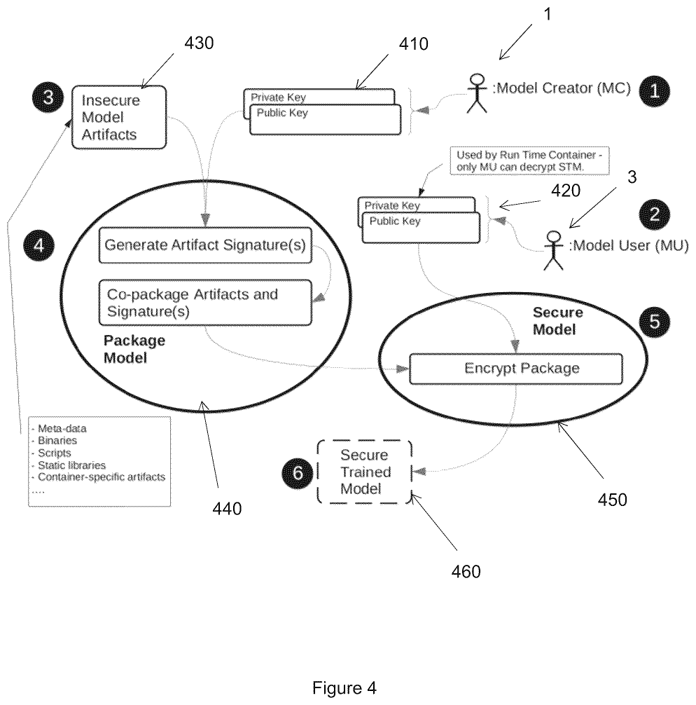

Before discussing use of the NFM, the security model will be considered in more detail with respect to FIG. 4, considering not only how the secure trained model is originally created and stored but also how it is provided to a model user (it is presumed for this discussion that the model user has already obtained the right to use the model under agreed conditions, which have been met). The model creator 1 establishes 410 a key pair (this may be specific to the particular creator/user interaction—possibly diversified from a master key pair) for use in connection with use by the model user 3, as does 420 the model user. At this point, the insecure model artefacts have been aggregated 430 as described above and packaged 440 for storage in a version signed by the model creator 1 and stored securely, with an associated NFM. When it established that the model user 3 is to have rights to use the STM, a package for use by that model user needs to be developed—this will typically be produced by use of both the model creator and model user key pairs. A standard way to do this is to establish a shared secret using Diffie-Hellman key exchange—this shared secret can then be used to encrypt 450 the STM into a deployable package 460. In embodiments, this could even be done in such a way that there was no risk of compromise by a malicious model user—for example, if the model user was granted access to a service interface over which the model could be run.

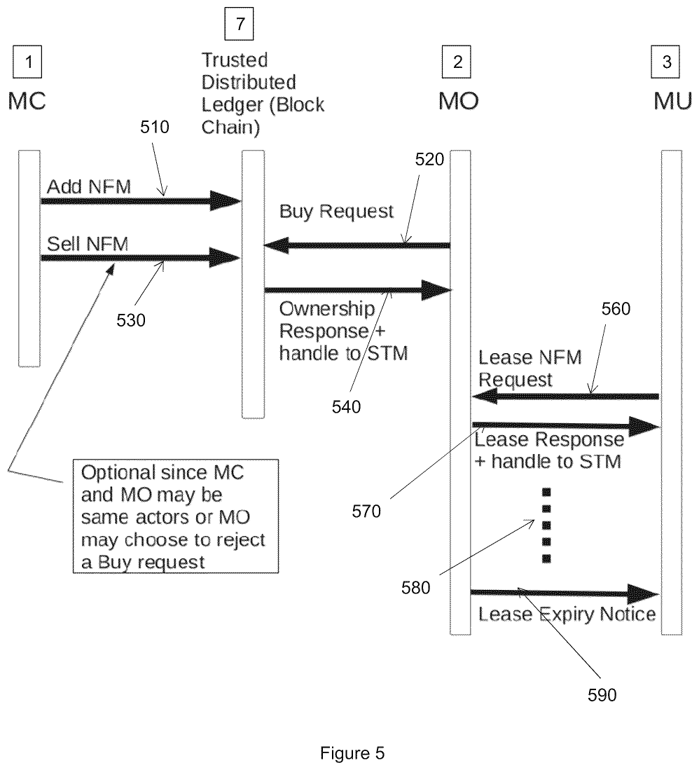

It should be noted here that the role of the model creator 1 may here be taken by the model owner 2—the model creator 1 may take no role after initial creation beyond establishing use of the model so that they can be appropriately rewarded for such use. The model management service 43 will now be considered in more detail with respect to FIG. 5.

Two processes are shown in FIG. 5. The first is the transfer of ownership of an STM to a model owner, which is achieved by transfer of the NFM to that model owner. First of all, the model creator 1 adds the NFM to the blockchain 7—this may be done in a conventional way using a conventional blockchain architecture. The NFM is stored 510 on the blockchain with an associated address indicating an address to go to in order to obtain rights in the STM (there may also be an identification of the model creator, but this is not essential) or to establish details of the STM to enable a prospective model owner or user to establish whether they may wish to acquire rights in the model. The prospective model owner can then make a “buy” request 520 in respect of the model, which is also here recorded on the blockchain 7. The model creator may accept or reject this request—here, it is assumed that the request is accepted, and a “sell” notification 530 is also stored on the blockchain 7, with any financial arrangements between the model creator 1 and the model owner 2 being established in parallel (these actions may all be carried out through the model management service 43). Appropriate rights to manage the STM are then passed 540 to the new model owner 2 along with ownership of the NFM. All stages of the transfer of ownership have been recorded on the blockchain 7, so the validity of the transaction can be proved.

The other process shown in FIG. 5 is the leasing of the NFM by a model user 3 to allow them to use the STM. Here, this is shown as a process carried out directly between model user 3 and model owner 2—which is possible if model owner address details are stored on the blockchain 7, for example—without recordal on the blockchain, though in other embodiments all these steps could be recorded on the blockchain 7 as well. The prospective model user 3 makes a request 560 to lease the NFM to the model owner 2. If this is accepted, the model owner 2 offers 570 and if a contract is made, works with the model user 3 to perform the steps 580 indicated in FIG. 4 for preparing the STM in a form for use by the model user 3. The model user 3 can then use the STM—within the terms of the lease—until the lease expires 590.

Access to the STM through creation of an NFM allows an effective market in trained models to be developed. An NFM will typically have the following characteristics, or associated benefits:
Each NFM is digital unique and cannot be conventionally copied, and acts as a proxy to an STM, which cannot be used unless use is granted through the NFM.
Ownership of every NFM can be traced and verified.
An NFM (and so also the digital assets associated with it) can be traded as digital artefacts (which may be 1-1, or 1-many) under a wide range of possible trading models.
The market for an NFM will typically only have technical constraints—which can be loosened if more technical resource is made available.
Model creators have freedom to determine whether to retain or trade ownership rights—in general, the full range of contractual options will be available.

The actual use of the trained model by the model user may be entirely conventional and need not be discussed further here, save to note that there are some circumstances where it may be desirable to allow another party access to the STM. One such party is a model trainer 8 as shown in FIG. 1, who may be needed if the STM needs adaptation or retraining to the circumstances of the model user. To allow the model trainer access, a similar process may be used to allow the model trainer 8 access to the STM as is shown in FIG. 4 for allowing the model user 3 access. If the need for the model trainer is known from the start, three-party Diffie-Hellman can be used to allow the model trainer rights—alternatively, the model owner may simply interact with the model trainer to allow them access.

With the model management service 43 operating as shown here, each party can interact with it to manage their rights, obligations and reward. The model creator 1 can establish use of the model, and so any benefit determined with the model owner 2 based on use. The model owner can establish use (and so revenue) and can control how the NFM (and so STM) can be leased—both what for, and for how long. The model user 3 can establish what NFMs are available and on what terms.

As the skilled person will appreciate, other embodiments may be provided within the spirit and scope of the invention as described here.

1. A method of providing a computer model as a tradeable asset, comprising:
preparing a trained computer model, comprising developing and training a computer model using training data and determining acceptance criteria for the computer model such that the computer model is determined to be a trained computer model when the acceptance criteria are met;
packaging the trained computer model for use by a third party and storing the trained computer model securely;
establishing a token corresponding to the trained computer model;
posting the token and transactions in the token to a blockchain such that the token is adapted for use as a tradeable asset; and
providing access to the trained computer model to a third party who has acquired rights to use the trained computer model through obtaining rights in the token.

2. The method of claim 1, wherein the trained computer model is a machine learning model.

3. The method of claim 1, wherein preparing the trained computer model comprises iterating a process of feature selection, algorithm selection, model building and model testing until the acceptance criteria are met.

4. The method of claim 1, wherein packaging the trained computer model further comprises a model creator digitally signing the trained computer model.

5. The method of claim 1, wherein storing the trained computer model securely comprises storing the trained computer model in encrypted form encrypted by a key controlled by a model creator or model owner.

6. The method of claim 1, wherein establishing the token comprises applying a hash function to the trained computer model and signing a hash result with a model creator private key.

7. The method of claim 1, wherein providing access to the trained computer model to the third party comprises establishing a shared secret between the third party and a model owner or model creator, and encrypting means of access to the trained computer model using the shared secret.

8. The method of claim 7, wherein the shared secret is established using Diffie-Hellman Key Exchange.

9. A system for developing of a computer model and providing it as a tradeable asset, the system comprising:
a model creation module adapted for a user to develop and train a computer model using training data and to determine that the computer model meets predetermined acceptance criteria, thereby producing a trained computer model;
a model packaging module for packaging the trained computer model for use by a third party, for storing the trained computer model securely, and for establishing a token corresponding to the trained computer model; and
a model management module for posting the token and transactions in the token to a blockchain such that the token is adapted for use as a tradeable asset, and for providing access to the trained computer model to a third party who has acquired rights to use the trained computer model through obtaining rights in the token.

10. The system of claim 9, wherein the module packaging module is adapted for the digital signing of the trained computer model by the user.

11. The system of claim 9, wherein the module packaging module is adapted for storing the trained computer model in encrypted form encrypted by a key controlled by the user.

12. The method of claim 2, wherein preparing the trained computer model comprises iterating a process of feature selection, algorithm selection, model building and model testing until the acceptance criteria are met.

13. The method of claim 2, wherein packaging the trained computer model further comprises a model creator digitally signing the trained computer model.

14. The method of claim 2, wherein storing the trained computer model securely comprises storing the trained computer model in encrypted form encrypted by a key controlled by a model creator or model owner.

15. The method of claim 2, wherein establishing the token comprises applying a hash function to the trained computer model and signing a hash result with a model creator private key.

16. The method of claim 2, wherein providing access to the trained computer model to the third party comprises establishing a shared secret between the third party and a model owner or model creator, and encrypting means of access to the trained computer model using the shared secret.

17. The method of claim 16, wherein the shared secret is established using Diffie-Hellman Key Exchange.

18. The method of claim 14, wherein providing access to the trained computer model to the third party comprises establishing a shared secret between the third party and a model owner or model creator, and encrypting means of access to the trained computer model using the shared secret.

19. The method of claim 18, wherein the shared secret is established using Diffie-Hellman Key Exchange.

20. A token being a digital asset formed by the steps of:
preparing a trained computer model, comprising developing and training a computer model using training data and determining acceptance criteria for the computer model such that the computer model is determined to be a trained computer model when the acceptance criteria are met;
packaging the trained computer model for use by a third party and storing the trained computer model securely;
establishing the token as corresponding to the trained computer model; and
posting the token and transactions in the token to a blockchain such that the token is adapted for use as a tradeable asset;
such that access is provided to the trained computer model to a third party who has acquired rights to use the trained computer model through obtaining rights in the token.
